(19) United States
(12) Patent Application Publication
(10) Pub. No.: US 2011/0063064 A1
(43) Pub. Date: Mar. 17, 2011

(54) POWER TRANSFORMER HAVING A STEPPING SWITCH

(76) Inventors: Wolfgang Albrecht, Wenzenbach (DE); Dieter Dohnal, Lappersdorf (DE); Rainer Frotscher, Regenstauf (DE); Klaus Schlepp, Maxhuette-Birkenhoehe (DE)

(21) Appl. No.: 12/989,668

(22) PCT Filed: Apr. 7, 2009
(86) PCT No.: PCT/EP2009/002542

§ 371 Date: Nov. 30, 2010

(30) Foreign Application Priority Data
Jun. 6, 2008 (DE) 10 2008 027 274.4

(51) Int. Cl. H01F 27/14; H01F 29/04

(52) U.S. Cl. 336/94; 336/150

(57) ABSTRACT

The abstract relates to an arrangement of an oil-filled power transformer having an oil-filled stepping switch, wherein only a single oil expansion vessel is provided, this oil expansion vessel being connected both to the oil volume of the stepping switch and also to the transformer tank, which is likewise oil-filled, via corresponding flanges.

The invention relates to an oil-filled power transformer with a similarly oil-filled on-load tap changer.

It is necessary, with both oil-filled power transformers and oil-filled on-load tap changers, to provide means for compensating for the thermal expansion of the oil.

Use is usually made for that purpose of oil expansion vessels which are connected by way of a pipe duct with the oil vessel of the transformer or the oil vessel of the on-load tap changer.

In addition, so-termed ‘expansion radiators’ are known which are mounted at the outer sides of the transformer and which are used at the same time for cooling and absorption of the thermal expansion of the oil. The usually present, often projecting is expansion vessel that is normally mounted above the transformer cover, is thereby superfluous. With the help of these expansion radiators it is possible to construct a closed system in which the transformer oil has no direct contact with the outside air and accordingly cannot oxidize (leading to oil ageing and formation of sludge). Hermetically closed systems of that kind also enable use of biologically degradable ester oils, which necessarily must be protected against oxidation, of low flammability based on regeneratable raw materials. Expansion radiators have a standard size that arises as an optimum of cooling area and variable volume. In this connection, the variable volume imposes high demands on the life of the material used. The on-load tap changer incorporated in the transformer is connected by way of a pipe duct with an individual expansion radiator that serves solely for absorption of the expansion in volume of the on-load tap changer oil. Due to the volume change, which is very small by comparison with the transformer oil, of the on-load tap changer oil the expansion radiator provided for the on-load tap changer is considerably over-sized.

Moreover, a solution with separate expansion vessels for transformer and on-load tap changer, the gas space of which is filled with nitrogen, is known. The gas spaces are directly connected by way of pipe ducts with nitrogen-filled compensating containers, the volume of which is dimensioned so that the pressure relationships arising due to the volume expansion of the oil remain within a predetermined permissible range above the overall operating temperature range (for example, between 0 and 0.5 bars excess pressure). The large nitrogen containers that enlarge the external dimensions of the transformer by approximately 20%, are disadvantageous here. In another form of embodiment the nitrogen cushion is disposed directly below the transformer cover or on-load tap changer cover, so that it is possible to dispense with any expansion vessel. Due to the significantly smaller gas volume an active pressure regulation with the help of a pressure regulating unit is required here, by which not only an impermissibly high excess pressure can be automatically discharged to the ambient air by way of a valve, but also compensation can be provided for subatmospheric pressure by injecting additional nitrogen from a compressed-gas bottle. The transformer requires specific high-voltage lead-throughs in order to be able to safely bridge over the insulating path in the gas space. Since the on-load tap changer has a gas space separate from the transformer, it is necessary to provide a nitrogen regulating unit specific to the on-load tap changer. The substantial additional technical outlay on the nitrogen regulating units is disadvantageous in this solution.

In addition, solutions with separate expansion vessels for transformer and on-load tap changer are known, in which a rubber bag or a rubber membrane by which an air exclusion of the oil is achieved is present in the interior space of the expansion vessel. The interior of the rubber bag or the surface of the rubber membrane remote from the oil is connected with the ambient air by way of an upstream drier. The limited service life of the rubber bag or the rubber membrane is disadvantageous here, since due to ageing processes the rubber becomes porous and thus permeable to oxygen after 10 to 15 years.

It is the object of the invention to indicate a simple solution by which, with low constructional outlay, compensation for thermal expansion of both the oil in the transformer tank and the separate on-load tap changer oil is possible.

This object is fulfilled by a power transformer with an on-load tap changer with the features of one of the two parallel claims 1 and 2.

The dependent claim relates to an advantageous development of each of the two possibilities according to claims 1 and 2.

The general inventive concept, which underlies the two possibilities in the parallel patent claims, consists of managing with a single expansion vessel for both the transformer and the on-load tap changer.

According to one form of embodiment in accordance with the invention the flange, which is present at the on-load tap changer head and which according to the prior art is provided for connection with a separate expansion vessel only for the on-load tap changer, is now connected by means of a pipe duct with the oil tank of the transformer. The flange at the transformer for connection of an expansion vessel—and only this—is actually connected with the single expansion vessel by way of a further pipe duct. The now single expansion vessel thus accepts in cascade manner the oil volume changes of both the on-load tap changer oil vessel and the transformer oil vessel.

According to a further form of embodiment in accordance with the invention, which is based on the same general concept, the two flanges of both the on-load tap changer and the transformer are connected together by way of a pipe duct and this pipe duct is again connected, by way of a further pipe duct, with the single expansion vessel. In both forms of embodiment an oil flow relay, which in the case of exceeding a defined oil flow limit value trips the circuit breaker of the transformer, is arranged in the pipe connection leading away from the flange of the on-load tap changer.

In this manner flows of oil above a limit value, which is specific to the on-load tap changer and which denotes possible faulty functioning of the on-load tap changer, can be reliably detected.

In both forms of embodiment of the invention it is useful to arrange on the on-load tap changer head a pressure relief valve which is known per se and which in the case of exceeding a fixedly preset excess pressure, for example 20 psi, opens virtually without delay and limits the excess pressure to the maximum permissible value. A greater degree of mechanical damage to either the on-load tap changer or the transformer is thus prevented.

The invention shall be explained in more detail in the following by way of example on the basis of drawings, in which:

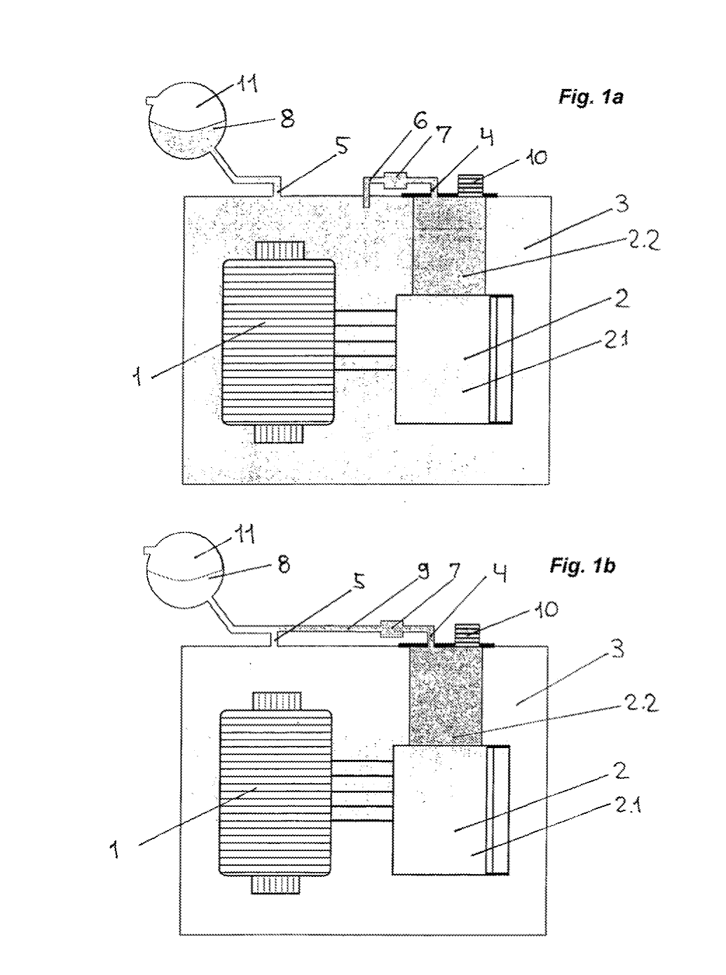

FIG. 1a shows a first form of embodiment of the invention according to patent claim 1 and

FIG. 1b shows a second form of embodiment of the invention according to patent claim 2.

Initially, FIG. 1a shall be explained. An electrical power transformer 1 and an on-load tap changer 2 disposed in connection therewith are shown in schematic illustration. In the illustrated form of embodiment the on-load tap changer 2 has a selector 2.1, which is arranged at the bottom and connected with the winding taps of the power transformer 1 by way of electrical connecting lines, as well as a load changeover switch 2.2, which is arranged thereabove, with an own oil-filled load changeover switch vessel. The entire arrangement is located in an oil-filled transformer tank 3. The on-load tap changer 2 has an upper flange 4 and the transformer tank 2 has, analogously, an upper flange 5.

The two flanges 4, 5 are, according to the prior art, connected with separate oil expansion vessels, expansion radiators or other means for volume compensation. According to the invention, here the flange 4 of the on-load tap changer is provided with a pipe duct 6 opening into the oil-filled transformer tank 3. An oil flow relay 7 is inserted into this pipe duct 6. Only the flange 5 of the transformer tank 3 leads, by way of a further pipe duct, to a single oil expansion vessel 8. The hermetic sealing of the oil is effected by means of, for example, a rubber bag 11, the interior of which is connected with the ambient air.

FIG. 1b shows a modified form of embodiment. The same components are provided with the same reference numerals; it is accordingly possible to dispense with a repeated explanation of the overall construction. By way of distinction, in this form of embodiment the flange 4 of the on-load tap changer 2 and the flange 5 of the transformer tank are connected by means of a common pipe duct 9. An oil flow relay 7 is again connected in this pipe duct 9. This common pipe duct 9 connecting the two flanges 4, 5 is for its part again connected with the single oil expansion vessel 8.

It is useful in both forms of embodiment to provide above the on-load tap changer head, i.e. outside the transformer tank 3, a pressure relief valve 10 such as is available, for example, under the trade designation MPreC®. The way in which it works has already been explained further above.

1. (canceled)

2. A power transformer with on-load tap changer, wherein both the power transformer and the on-load tap changer are oil-filled, wherein the on-load tap changer is arranged in the transformer tank of the transformer and wherein both the transformer and on-load tap changer have at the upper sides thereof a respective connecting flange for connection with an oil expansion vessel, wherein the connecting flange of the on-load tap changer and the connecting flange of the transformer tank are connected together by means of a pipe duct, that an oil flow relay is arranged in this pipe duct and that the common pipe duct leads to a single oil expansion vessel.

3. The power transformer with on-load tap changer according to claim 1 wherein a pressure relief valve connected with the oil volume of the on-load tap changer is arranged above the on-load tap changer head of the on-load tap changer.

4. A power transformer with on-load tap changer, wherein both the power transformer and the on-load tap changer are oil-filled, wherein the on-load tap changer is arranged in the transformer tank of the transformer, wherein both the transformer and on-load tap changer have at the upper sides thereof a respective connecting flange for connection with an oil expansion vessel and wherein the connecting flange of the on-load tap changer leads by way of a pipe duct into the interior of the transformer tank of the power transformer, wherein the end of the pipe duct leading into the interior of the transformer tank is open in such a manner that the oil volumes of on-load tap changer and power transformer are connected with one another, that an oil flow relay is arranged in this pipe duct and that only the connecting flange of the transformer tank leads to a single oil expansion vessel.
